(19) United States
(12) Patent Application Publication
(10) Pub. No.: US 2013/0117711 A1
(43) Pub. Date: May 9, 2013

(54) RESIZE HANDLE ACTIVATION FOR RESIZABLE PORTIONS OF A USER INTERFACE

(71) Applicants: Kyle E.B. Hayes, Reading (GB); Christopher Monahan, Hursley (GB); Thomas L. Roach, Winchester (GB); Domanic Smith-Jones, Hursley (GB); Joseph R. Winchester, Hursley (GB)

(72) Inventors: Kyle E.B. Hayes, Reading (GB); Christopher Monahan, Hursley (GB); Thomas L. Roach, Winchester (GB); Domanic Smith-Jones, Hursley (GB); Joseph R. Winchester, Hursley (GB)

(73) Assignee: International Business Machines Corporation, Armonk, NY (US)

(21) Appl. No.: 13/290,064

(22) Filed: Nov. 5, 2011

(51) Int. Cl. G06F 3/048

(52) U.S. Cl. 715/800

(57) ABSTRACT

Embodiments of the present invention provide a method, system and computer program product for resize handle display management in a graphical user interface (GUI). In an embodiment of the invention, a method for resize handle display management in a GUI is provided. The method includes receiving a directive to display a resize handle for each resizable GUI control in a window, such as by way of a keyboard shortcut. The method additionally includes determining each resizable GUI control in the window, including any separators that separate two resizable regions of a window. Finally, the method includes displaying the window with at least one resize handle for each determined resizable GUI control in the window.

### BACKGROUND OF THE INVENTION

1. Field of the Invention

The present invention relates to the field of the graphical user interface (GUI) and more particularly to the rendering and manipulation of resize handles in a window.

2. Description of the Related Art

The modern computing environment provides for an operating system upon which one or more computer programs execute. The operating system, typically a windowing operating system, includes a library of GUI controls able to be invoked by hosted computer programs. Many of the GUI controls, such as radio buttons and static text fields are sized at design time and cannot be enlarged or reduced in size at run-time. The size of these controls is either fixed or varies as the containing window itself is resized. To allow more fine control over how the controls within the window are arranged to occupy the client area, areas within the window itself can be moveable giving the user more dynamic control over how the window's controls are sized and positioned. This is typically done with sash forms, or resizeable separators, or by placing controls onto scrollable areas. In addition, some GUI controls are dynamically resizable by virtue of being able to scroll and vary the visible area shown within the viewport. Dynamically resizable GUI controls such as some text input fields, lists, columns of a table, and windows themselves can be resized horizontally, vertically, or both by way of keyboard or pointing device operation (such as a mouse) when the viewable area is not large enough to show the total contents of the control in its viewport.

Typically, to facilitate the resizing of a GUI control, a resize handle can be rendered as a pointing device passes in proximity to a graphical element of a GUI control able to manage resizing of the GUI control. Generally, a resize handle is a small box that appears at each of the corners of a selected GUI control (and sometimes at the sides of the GUI control also and sometimes in the centre of the control or along one of its edges) that can be dragged to alter the size of the GUI control. A resize box is a variant or species of a resize handle usually positioned at the bottom-right hand corner of a GUI control, used to change the size of the GUI control (typically a window or dialog box) by dragging the GUI control to the desired size. A resize corner is yet another variation or species of the resize handle in that the resize corner is a special region at the corner of a window, used to change the size of the window by dragging the corner of the window to the desired size. While resize boxes are usually positioned only at the bottom-right corner of the window, resize corners are at all four corners of the window. Resize controls for sashes and moveable separators are usually double ended arrows indicating the available directions of available resize movement.

When a window becomes resized, the application will typically reposition those GUI controls contained therein to make best use of the available space resulting from the resizing of the window. To the extent that only a window can be resized in a GUI, the task of repositioning the contained GUI controls is of limited complexity. However, to the extent that a resizable window in of itself contains resizable GUI controls, the task of repositioning other GUI controls in the window can be more complicated. To facilitate the process of repositioning GUI controls where some of the GUI controls including a window itself are resizable, a window can be subdivided into different regions. To that end, the region itself can be resizable by dragging a separator or “sash” in one direction or another to enlarge or contract the area in which contained GUI controls can be repositioned.

To the extent that multiple, different GUI controls in a GUI can be resized, as well as one or more regions resizable by operation of a separator or sash, the end user can be compelled to engage in a series of trial-and-error mouse pointing operations to identify those GUI controls and regions that can be resized whenever a mouse cursor transforms visually into a resize handle. When too many GUI controls are resizable within a window, determining and recalling those GUI controls and regions that are resizable can be tedious and inefficient.

### BRIEF SUMMARY OF THE INVENTION

Embodiments of the present invention address deficiencies of the art in respect to managing resizing of GUI controls in a GUI and provide a novel and non-obvious method, system and computer program product for resize handle display management in a GUI. In an embodiment of the invention, a method for resize handle display management in a GUI is provided. The method includes receiving a directive to display a resize handle for each resizable GUI control in a window, such as by way of a keyboard shortcut. The method additionally includes determining each resizable GUI control in the window, including any separators that separate two resizable regions of a window. Finally, the method includes displaying the window with at least one resize handle for each determined resizable GUI control in the window.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for resize handle display management in a GUI;

FIG. 2 is a schematic illustration of a data processing system configured for resize handle display management in a GUI; and,

FIG. 3 is a flow chart illustrating a process for resize handle display management in a GUI.

### DETAILED DESCRIPTION OF THE INVENTION

Embodiments of the invention provide for resize handle display management in a GUI. In accordance with an embodiment of the invention, an event can be received directing a display of all available resize handles to resize correspondingly available resizable GUI controls in a window (including other windows and defined regions contained therein). Responsive to the receipt of the event, an inventory of GUI controls (including other windows and defined regions) can be consulted to identify resizable ones of the GUI controls in the window. For each identified GUI control determined to be resizable, at least one resize handle can be displayed in visual proximity to a portion of the GUI control that controls resizing of the GUI control. In this way, the end user can quickly visually determine all resizable GUI controls in a window.

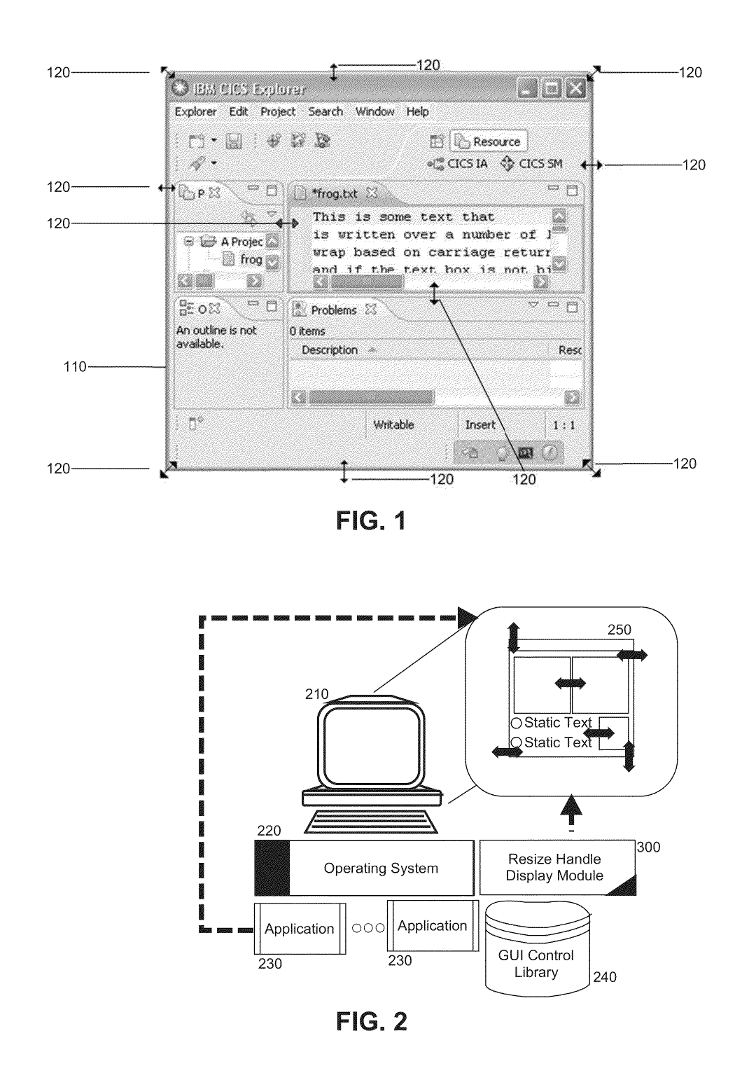

In further illustration, FIG. 1 is a pictorial illustration of a process for resize handle display management in a GUI. As shown in FIG. 1, a window 110 can include different GUI controls, some of which can be resizable such as the window 110 itself, a text window through which text can be displayed, and a sash or separator partitioning a portion of the window 110 into separate regions. In response to detecting a request to visualize resize handles 120 for all of the resizable GUI controls including the window 110 itself and the separator, the resizable GUI controls including the separator can be identified and all of the resize handles 120 for the identified resizable GUI controls including the window 110 itself and the separator can be displayed concurrently.

The process described in connection with FIG. 1 can be implemented within a conventional data processing system. In yet further illustration, FIG. 2 schematically shows a data processing system configured for resize handle display management in a GUI. The system can include a host computer 210 that includes at least one processor and memory, fixed storage, a display and one or more input methods such as a keyboard, mouse and the like. The host computer 210 can support the execution of an operating system 220. The operating system 220 can provide an execution environment in the host computer 210 for one or more applications 230 including managing access by the applications 230 to the computing resources of the host computer 210.

Of note, the operating system 220 can include a GUI control library 240 of GUI controls for use by the applications 230. Those GUI controls can include one or more window types, dialog boxes, text fields, buttons, window separators and the like. In this way, an application 230 can use the GUI controls programmatically defined in the GUI control library 240 to provide a GUI 250 for the application 230. Further, the GUI 250 provided for the application 230 can be configured to display a resize handle in response to a proximity event of a pointer to a portion of a GUI control determined to be resizable. In this way, the proximate GUI control can be resized through the operation of the resize handle.

Importantly, a resize handle display module 300 can be coupled to the operating system 220. The resize handle display module 300 can include program code that when executed in the memory of the host computer 210 can be enabled to receive or detect an event or message directing a concurrent display of all resize handles in the GUI 250 so that an end user can visualize all resizable elements of the GUI 250. In response, the program code of the module 300 can inspect the content of the GUI 250 to identify all resizable elements of the GUI 250 and can concurrently display corresponding resize handles for all identified resizable elements of the GUI 250.

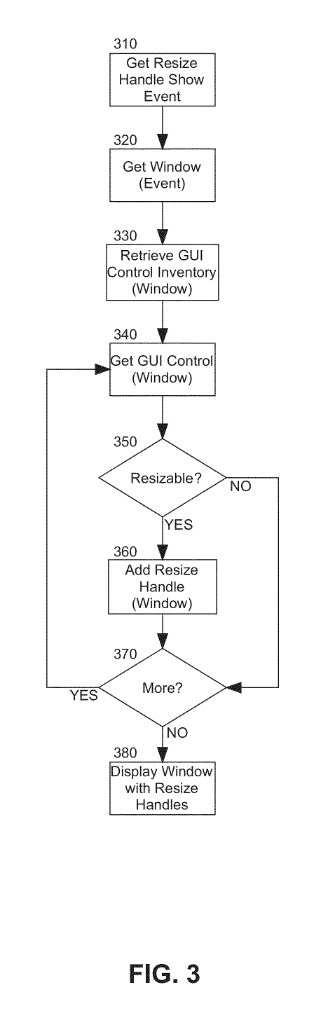

In even yet further illustration of the operation of the resize handle display module, FIG. 3 is a flow chart illustrating a process for resize handle display management in a GUI. Beginning in block 310, a resize handle show event can be received and in response, in block 320 a window associated with the event can be determined and in block 330, an inventory of GUI controls for the window can be ascertained.

In block 340, a first GUI control in the inventory can be selected and in decision block 350 it can be determined if the GUI control is resizable. If so, in block 360 a resize handle for each portion of the GUI control that are resizable can be added to a display of the window. Thereafter, in decision block 370 it can be determined if additional GUI controls remain to be processed in the inventory. If so, the process can return to block 340 where a next GUI control can be selected and again, in decision block 350 it can be determined if the GUI control is resizable. If so, again in block 360 a resize handle for each portion of the GUI control that are resizable can be added to a display of the window. In decision block 370, when no additional GUI controls remain to be processed in the inventory, in block 380 the window can be redrawn to include a concurrent display of the resize handles for the resizable GUI controls of the window.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for resize handle display management in a graphical user interface (GUI) comprising:
receiving a directive to display a resize handle for each resizable GUI control in a window;
determining each resizable GUI control in the window; and,
displaying the window with at least one resize handle for each determined resizable GUI control in the window.

2. The method of claim 1, wherein the directive is a keyboard shortcut.

3. The method of claim 1, wherein the resizable GUI control comprises a separator separating two different regions of the window that can be resized.

4. The method of claim 1, wherein the resizable GUI controls in the window are determined in reference to an inventory of GUI controls for the window.

5. The method of claim 1, wherein a resize handle is displayed for each resizable GUI control in the window at each resizable portion of each resizable GUI control in the window.

6. A data processing system configured for resize handle display management in a graphical user interface (GUI), the system comprising:
an operating system executing in memory of a host computer and configured to manage different applications accessing computing resources of the host computer;
a GUI control library of GUI controls provided for use by the applications in generating respective GUIs; and,
a resize handle display module coupled to the operating system, the module comprising program code enabled to perform upon execution in the memory of the computer:
receiving a directive to display a resize handle for each resizable GUI control in a window;
determining each resizable GUI control in the window; and,
displaying the window with at least one resize handle for each determined resizable GUI control in the window.

7. The system of claim 6, wherein the directive is a keyboard shortcut.

8. The system of claim 6, wherein the resizable GUI control comprises a separator separating two different regions of the window that can be resized.

9. The system of claim 6, wherein the resizable GUI controls in the window are determined in reference to an inventory of GUI controls for the window.

10. The system of claim 6, wherein a resize handle is displayed for each resizable GUI control in the window at each resizable portion of each resizable GUI control in the window.

11. A computer program product for resize handle display management in a graphical user interface (GUI), the computer program product comprising:
a computer readable storage medium having computer readable program code embodied therewith, the computer readable program code comprising:
computer readable program code for receiving a directive to display a resize handle for each resizable GUI control in a window;
computer readable program code for determining each resizable GUI control in the window; and,
computer readable program code for displaying the window with at least one resize handle for each determined resizable GUI control in the window.

12. The computer program product of claim 11, wherein the directive is a keyboard shortcut.

13. The computer program product of claim 11, wherein the resizable GUI control comprises a separator separating two different regions of the window that can be resized.

14. The computer program product of claim 11, wherein the resizable GUI controls in the window are determined in reference to an inventory of GUI controls for the window.

15. The computer program product of claim 11, wherein a resize handle is displayed for each resizable GUI control in the window at each resizable portion of each resizable GUI control in the window.
